(19) United States
(12) Patent Application Publication
(10) Pub. No.: US 2018/0372237 A1
(43) Pub. Date: Dec. 27, 2018

(54) NORMALLY CLOSED FAST-ACTING SOLENOID VALVE

(71) Applicant: Schaeffler Technologies AG & Co. KG, Herzogenaurach (DE)

(72) Inventors: Donald J. Dixon, Ortonville, MI (US); Roxana Javid-Pietron, Bloomfield, MI (US)

(21) Appl. No.: 15/629,859

(22) Filed: Jun. 22, 2017

(51) Int. Cl. F16K 31/06; F02D 41/00

(52) U.S. Cl. CPC F16K 31/0655; F02D 2041/001; F02D 41/0002

(57) ABSTRACT

A normally closed fast-acting solenoid valve is provided that prevents hydraulic fluid leakage from a fluid gallery of a hydraulic system in a de-energized state. The solenoid valve includes a bobbin, an armature, a yoke, a core, a push pin, a hydraulic housing, a valve body biased by a biasing element, and a valve seat. The armature has a first coil-de-energized axial position and a second coil-energized axial position. In the first axial position, the valve body is biased into engagement with the valve seat by the biasing element. In the second axial position, the valve body is disengaged with the valve seat.

### TECHNICAL FIELD

Example aspects described herein relate to solenoid valves, and, more particularly, to fast-acting solenoid valves used in variable valve lift or variable valve timing systems of internal combustion engines for automobiles.

### BACKGROUND

Variable valve lift (VVL) and variable valve timing (VVT) systems of internal combustion (IC) engines often manage hydraulic fluid flow, leakage or pressure within a network of fluid galleries to vary the output of these respective systems. This type of hydraulic fluid management is typically handled by a solenoid valve which can be precisely controlled by an engine control unit (ECU). A solenoid valve that can quickly respond and actuate to an ECU command is critical to the function of many VVL and VVT systems.

Within these IC engine systems it is often desirable to prevent leakage or drain-out of the hydraulic fluid from the fluid gallery or galleries after the engine has been shut down to enable timely actuation of these systems upon start-up. In some VVL or VVT systems, such leakage can lead to extended start-up times or erratic combustion, both of which are undesirable to the end-user.

FIG. 5 shows a prior art normally open fast-acting solenoid valve (NOFASV) 100 together with a simplified representation of a housing 104 that includes a fluid gallery 106 and a hydraulic system 108. The housing 104 could also be a cylinder head and the hydraulic system 108 could also be a VVL or VVT system. In FIG. 5, the NOFASV 100 is shown in a de-energized state. In this state, a bias element 140 forcibly acts upon a valve body 136, moving it upward to open up a passage between the valve body 136 and a valve seat 144. This de-energized state could be representative of an engine shutdown condition during which no electrical energy is provided to the NOFASV 100 through electrical terminal 164. During this engine shutdown condition, hydraulic fluid 107 is allowed to flow out of the fluid gallery 106, through an outlet port 146, through the passage between the valve body 136 and valve seat 144, and out through either of three inlet ports 154A-154C. Upon start-up of the IC engine, valuable time is required to re-fill the fluid gallery 106, potentially delaying usage of the VVL or VVT system. A solution is needed to prevent hydraulic fluid leakage from these systems after engine shutdown.

### SUMMARY OF THE INVENTION

A normally closed fast-acting solenoid valve is provided that prevents hydraulic fluid leakage from a fluid gallery of a hydraulic system in a de-energized state. The solenoid valve includes a bobbin, an armature, a yoke, a core, a push pin, a hydraulic housing, a valve body, and a valve seat. The bobbin is configured to support a coil; the coil, when energized with electric current, is capable of producing a magnetic field. The armature has at least a portion that is circumferentially surrounded by the bobbin and is axially displaceable by the magnetic field. A yoke circumferentially surrounds at least a portion of the armature. A core is axially adjacent to a lower axial end of the armature. A push pin has a first portion coupled to the armature, a second portion disposed within a clearance through-aperture of the core, and an actuating portion that is arranged to axially displace the valve body. A biasing element is engaged with the valve body. A hydraulic housing, engaged with a hydraulic end of the core, has a central aperture, at least one inlet port, at least one outlet port, a valve seat, and a retainer. The retainer is engaged with a lower end of the biasing element.

The valve body has a first coil-de-energized axial position and a second coil-energized axial position. In the first axial position, the valve body is biased into engagement with the valve seat by the biasing element. In the second axial position, the valve body is disengaged with the valve seat.

### BRIEF DESCRIPTION OF DRAWINGS

The above mentioned and other features and advantages of the embodiments described herein, and the manner of attaining them, will become apparent and be better understood by reference to the following descriptions of multiple example embodiments in conjunction with the accompanying drawings. A brief description of the drawings now follows.

FIG. 1 is a perspective view of an example embodiment of a normally closed fast-acting solenoid valve.

FIG. 2A is a cross-sectional view of the solenoid valve of FIG. 1 in a de-energized state.

FIG. 2B is a detailed view taken from FIG. 2A.

FIG. 3A is a cross-sectional view of the solenoid valve of FIG. 1 in an energized state.

FIG. 3B is a detailed view taken from FIG. 3A.

FIG. 4 is an isometric view of a valve body and valve seat shown in FIGS. 2A through 3B.

FIG. 5 is a cross-sectional view of a prior art normally open fast-acting solenoid valve.

### DETAILED DESCRIPTION OF THE INVENTION

Identically labeled elements appearing in different figures refer to the same elements but may not be referenced in the description for all figures. The exemplification set out herein illustrates embodiments which should not be construed as limiting the scope of the claims in any manner. A radially inward direction is from an outer radial surface, toward the central axis or radial center of the component. Conversely, a radial outward direction indicates the direction from the central axis or radial center of the component toward the outer surface. Axially refers to directions along a diametric central axis. The words “upper”, “lower”, “upward”, “downward”, “above” and “below” designate directions in the drawings to which reference was made.

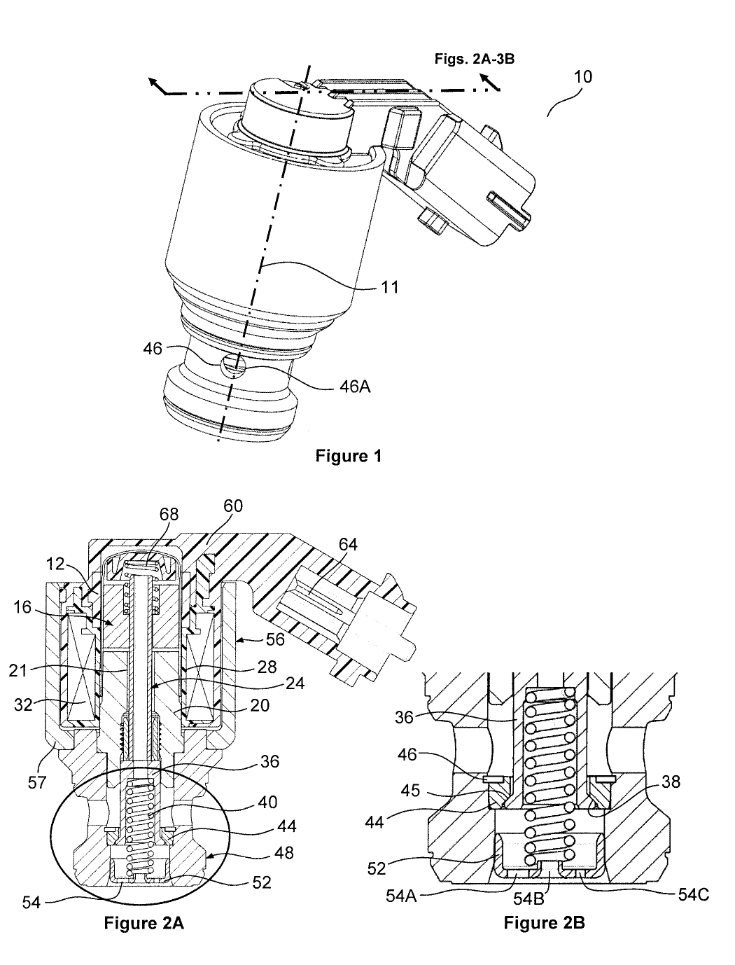

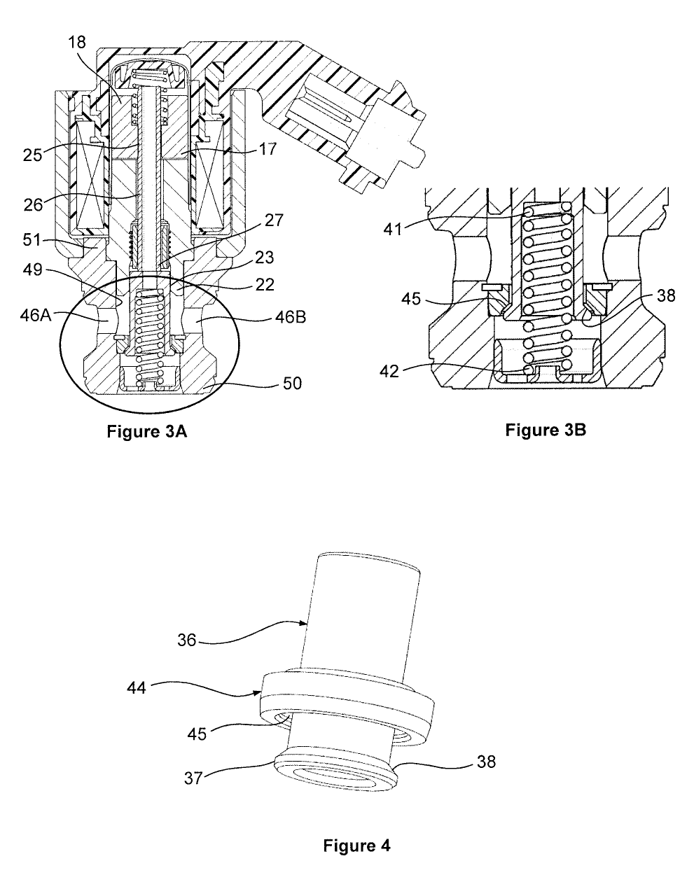

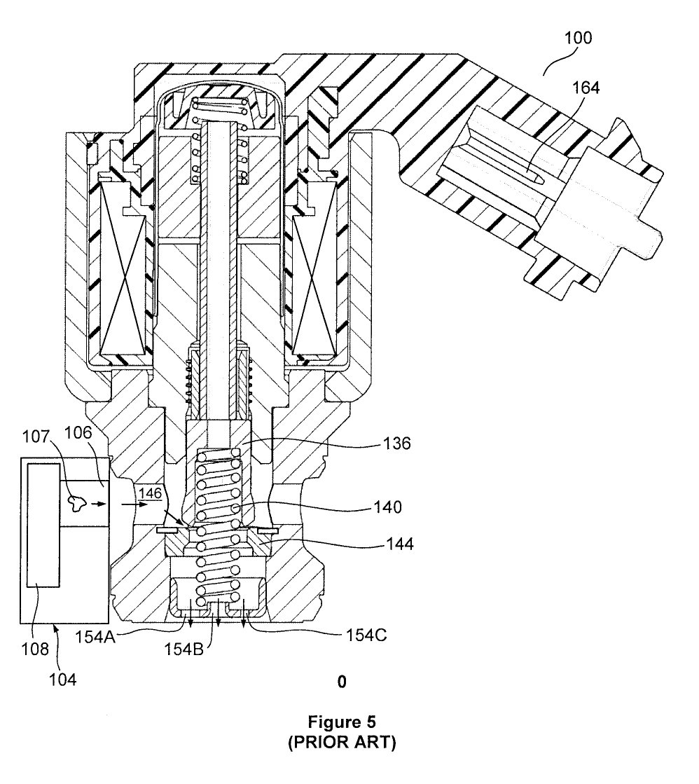

Referring to FIG. 1, an example embodiment of a normally closed fast-acting solenoid valve (NCFASV) 10 is shown with a central axis 11. Referring now to FIG. 2A, a cross-sectional view of the NCFASV 10 is shown in a first coil-de-energized axial position; FIG. 2B shows a detailed view of a portion of the NCFASV 10 of FIG. 2A; FIG. 3A shows a cross-sectional view of the NCFASV 10 in a second coil-de-energized axial position; FIG. 3B shows a detailed view of a portion of the NCFASV 10 of FIG. 3A; and, FIG. 4 is an isometric view of a valve body and valve seat shown in FIGS. 2A through 3B. The following description should be viewed in light of FIGS. 1 through 4. The NCFASV 10 includes a bobbin 28 that radially houses a coil 32. The coil 32 becomes energized when it receives electric current via an electric terminal 64. The presence of electric current in the coil 32 induces a magnetic field which causes an armature 16, at least a portion of which is circumferentially surrounded by the bobbin 28, to move axially downward. A yoke 12 circumferentially surrounds at least a portion of the armature 16. A core 20 is axially adjacent to a lower axial end 17 of the armature 16. The armature 16 is coupled to a first portion 25 of a push pin 24, possibly facilitated by a press-fit; a second portion 26 of the push pin 24 extends through a clearance through-aperture 21 that extends through the core 20; and, an actuating portion 27 of the push pin 24 displaces a valve body 36. The valve body 36 can be partially disposed within a valve body aperture 23 arranged at a hydraulic end 22 of the core 20 and partially within a central aperture 49 of a hydraulic housing 48 that is engaged with the hydraulic end 22 of the core 20. Other valve body interface arrangements along with other core and hydraulic housing designs are possible. The valve body 36 is forcibly engaged by an upper end 41 of a biasing element 40. Other design variations of how the biasing element 40 engages the valve body 36 are possible. The valve body 36 has a radially outward protrusion 37 configured with a seating land 38 to engage a receiving surface 45 of a valve seat 44 disposed within the central aperture 49 of the hydraulic housing 48. The seating land 38 can be of any shape that serves as an optimum contact interface, including angled or crowned. A lower end 42 of the biasing element 40 is engaged with a retainer 52 arranged at an inlet end 50 of the hydraulic housing 48. Both the valve seat 44 and the retainer 52 can be integrally formed within the central aperture 49 of the hydraulic housing 48, or be separately formed components that are installed within the central aperture 49. Various attachment methods of the valve seat 44 and retainer 52 within the central aperture 49 are possible, such as a press-fit or other suitable design forms; for example, a retaining clip 46 may be applied to limit axial movement of the valve seat 44, as shown in FIG. 2B.

An overmold body 60 extends radially from the top of the NCFASV 10 and houses the electrical terminal 64. A solenoid housing 56 circumferentially surrounds the coil 32 with a bottom end 57 of the solenoid housing 56 engaging a coil end 51 of the hydraulic housing 48. Other designs for coupling the solenoid housing 56 to the NCFASV 10 are possible.

The valve body 36 is capable of two axial positions. In a first coil-de-energized axial position, shown in FIGS. 2A and 2B, the biasing element 40 pushes the valve body 36 axially upward until the seating land 38 engages the receiving surface 45 of the valve seat 44. In this first coil-de-energized axial position, hydraulic is prevented from flowing through the outlet port 46 (or multiple outlet ports 46A-46C) and exiting the NCFASV 10 through the inlet port 54 (or multiple inlet ports 54A-54C). Simply stated, the first coil-de-energized axial position prevents flow from the outlet port 46 to the inlet port 54. The first coil-de-energized axial position is a likely state for the NCFASV 10 during an IC engine-off condition. With the valve body 36 in a closed position, drain-out of fluid galleries for a hydraulic system, such as a VVL or VVT system, is prevented.

An optional design feature includes a damper 68 that can be arranged at a top end 18 of the armature 16 of the NCFASV 10. Many different forms and locations of dampers are possible to satisfy any variety of damping functions.

In a second coil-energized axial position, shown in FIGS. 3A and 3B, the armature 16 and push pin 24 move axially downward due to the presence of electric current in the coil 32 and resultant magnetic field; the valve body 36 is displaced downward such that separation occurs between seating land 38 of the valve body 36 and the receiving surface 45 of the valve seat 44. In this second coil-energized axial position, hydraulic fluid that enters the inlet port 54 (or multiple inlet ports 54A-54C) flows between the valve body 36 and valve seat 44 and exits through the outlet port 46 (or multiple outlet ports 46A-46C) supplying hydraulic fluid to a fluid gallery (or galleries) of a hydraulic system such as a VVL or VVT system of an IC engine. Therefore, it could be simply stated that the second coil-energized axial position facilitates flow of hydraulic fluid from the inlet port 54 to the outlet port 46 of the NCFASV 10.

In the foregoing description, example embodiments are described. The specification and drawings are accordingly to be regarded in an illustrative rather than in a restrictive sense. It will, however, be evident that various modifications and changes may be made thereto, without departing from the broader spirit and scope of the present invention.

In addition, it should be understood that the figures illustrated in the attachments, which highlight the functionality and advantages of the example embodiments, are presented for example purposes only. The architecture or construction of example embodiments described herein is sufficiently flexible and configurable, such that it may be utilized (and navigated) in ways other than that shown in the accompanying figures.

Although example embodiments have been described herein, many additional modifications and variations would be apparent to those skilled in the art. It is therefore to be understood that this invention may be practiced otherwise than as specifically described. Thus, the present example embodiments should be considered in all respects as illustrative and not restrictive.

What we claim is:

1. A solenoid valve comprising:
a central axis;
a bobbin configured to support a coil, the coil, when energized with electric current, capable of producing a magnetic field;
an armature, at least a portion circumferentially surrounded by the bobbin and axially displaceable by the magnetic field;
a yoke, circumferentially surrounding at least a portion of the armature;
a core, axially adjacent to a lower axial end of the armature;
a push pin having:
a first portion coupled to the armature;
a second portion disposed within a clearance through-aperture of the core; and,
an actuating portion arranged to axially displace a valve body;
a biasing element engaged with the valve body; and,
a hydraulic housing, engaged with a hydraulic end of the core, the hydraulic housing having:
a central aperture;
at least one inlet port;
at least one outlet port;
a valve seat for receiving the valve body; and,
a retainer engaged with a lower end of the biasing element; and,
the valve body having:
a first coil-de-energized axial position with the valve body biased into engagement with the valve seat by the biasing element; and,
a second coil-energized axial position with the valve body disengaged with the valve seat.

2. The solenoid valve of claim 1, wherein the first coil-de-energized axial position prevents flow of hydraulic fluid from the at least one outlet port to the at least one inlet port.

3. The solenoid valve of claim 1, wherein the second coil-energized axial position facilitates flow of hydraulic fluid from the at least one inlet port to the at least one outlet port.

4. The solenoid valve of claim 1, wherein the valve seat is a separately formed component installed within the hydraulic housing.

5. The solenoid valve of claim 4, wherein the valve seat is retained within the hydraulic housing by a retaining clip.

6. The solenoid valve of claim 1, wherein the valve seat is configured with a receiving surface for receiving the valve body.

7. The solenoid valve of claim 1, wherein the spring retainer is a separately formed component installed within the hydraulic housing.

8. The solenoid valve of claim 7, wherein the spring retainer is press-fit within the hydraulic housing.

9. The solenoid valve of claim 1, wherein the spring retainer is formed with the at least one inlet port.

10. The solenoid valve of claim 1, wherein the spring retainer is arranged on an inlet end of the hydraulic housing.

11. The solenoid valve of claim 1, wherein an upper end of the biasing element is engaged with the valve body.

12. The solenoid valve of claim 1, wherein a valve housing circumferentially surrounds the coil.

13. The solenoid valve of claim 12, wherein a bottom end of the valve housing is engaged with the hydraulic housing.

14. The solenoid valve of claim 1, further comprising a damper arranged at a top end of the armature.

15. The solenoid valve of claim 1, wherein the valve body is configured with a radially outward protrusion having a seating land.

16. The solenoid valve of claim 15, wherein the seating land is angled.

17. The solenoid valve of claim 1, wherein a hydraulic end of the core is disposed within the central aperture of the hydraulic housing.

18. The solenoid valve of claim 1, wherein the first portion of the push pin is coupled to the armature by a press-fit.

19. The solenoid valve of claim 1, wherein the valve body is at least partially received by a valve body aperture arranged at the hydraulic end of the core.
